(19) United States
(12) Patent Application Publication
(10) Pub. No.: US 2022/0046576 A1
(43) Pub. Date: Feb. 10, 2022

(54) APPARATUS, METHOD AND COMPUTER PROGRAM FOR PERFORMING RADIO ACCESS NOTIFICATION AREA UPDATE

(71) Applicant: NOKIA TECHNOLOGIES OY, Espoo (FI)

(72) Inventors: Mads Lauridsen, Gistrup (DK); Frank Frederiksen, Klarup (DK); Daniela Laselva, Klarup (DK)

(21) Appl. No.: 17/309,652

(22) PCT Filed: Mar. 28, 2019
(86) PCT No.: PCT/EP2019/057937

§ 371 Date: Jun. 11, 2021

(51) Int. Cl. H04W 60/04; H04W 76/20; H04W 76/30

(52) U.S. Cl. CPC H04W 60/04; H04W 76/30; H04W 76/20

(57) ABSTRACT

There is disclosed an apparatus. The apparatus comprises means for performing: when the apparatus is in an INACTIVE radio resource control state, transitioning from the INACTIVE radio resource control state to an IDLE radio resource control state, when it is determined by the apparatus that the apparatus has performed a radio access network notification area update a number of times that is equal to or greater than a configured number, N.

### FIELD

This disclosure relates to communications, and more particularly to apparatus, methods and computer programs in a wireless communication system. More particularly the present invention relates to power saving of user equipment in a wireless communication system.

### BACKGROUND

A communication system can be seen as a facility that enables communication between two or more devices such as user terminals, machine-like terminals, base stations and/or other nodes by providing communication channels for carrying information between the communicating devices. A communication system can be provided for example by means of a communication network and one or more compatible communication devices. The communication may comprise, for example, communication of data for carrying data for voice, electronic mail (email), text message, multimedia and/or content data communications and so on. Non-limiting examples of services provided include two-way or multi-way calls, data communication or multimedia services and access to a data network system, such as the Internet.

A communication system and associated devices typically operate accordance with a given standard or specification which sets out what the various entities associated with the system are permitted to do and how that should be achieved.

Since introduction of fourth generation (4G) services increasing interest has been paid to the next, or fifth generation (5G) standard. 5G may also be referred to as a New Radio (NR) network. 5G introduced a new radio resource control (RRC) state, namely RRC_INACTIVE.

### STATEMENT OF INVENTION

According to a first aspect there is provided an apparatus comprising means for performing: when the apparatus is in an INACTIVE radio resource control state, transitioning from the INACTIVE radio resource control state to an IDLE radio resource control state, when it is determined by the apparatus that the apparatus has performed a radio access network notification area update a number of times that is equal to or greater than a configured number, N.

According to some examples, the means are further configured to operate a timer to determine whether the apparatus has performed a radio access network notification area update a number of times that is equal to or greater than the configured number, N, within a time window.

According to some examples, each radio access network notification area update is due to one or more of: movement of the apparatus; environmental factors; cell movement.

According to some examples, the means are further configured to perform changing from the INACTIVE radio resource control state to the IDLE radio resource control state instead of initiating a radio access network notification area update procedure with a network.

According to some examples, the means are further configured to perform determining a number of traffic events, x, experienced by the apparatus over a time window, y.

According to some examples, the means are further configured to perform the transitioning from the INACTIVE radio resource control state to the IDLE radio resource control state, when it is determined by the apparatus that the apparatus has performed a radio access network notification area update a number of times that is equal to or greater than the configured number, N, and the number of traffic events is less than or equal to x.

According to some examples, the configured number, N, takes in to account information of one or more of: movement of the apparatus; downlink traffic of the apparatus; uplink traffic of the apparatus; a number of other apparatus in the INACTIVE state; cell movement.

According to some examples, N is configured by the apparatus.

According to some examples, N is network configured.

According to some examples, once in the IDLE state the means are further configured to perform listening for network paging messages according to an IDLE configuration, unless the apparatus had an apparatus-specific paging configuration in the INACTIVE state, in which case the apparatus is configured to continue using the apparatus-specific paging configuration when in the IDLE state.

According to some examples, the means are further configured t simultaneously support INACTIVE and IDLE paging.

According to some examples, the means are further configured to support the INACTIVE and IDLE paging during a time period set by a timer, the time period based on radio access network notification area update periodicity and a last periodic radio access network notification area update that was made.

According to some examples, the apparatus comprises a user equipment.

According to some examples, the means comprises: at least one processor; and at least one memory including computer program code, the at least one memory and the computer program code configured to, with the at least one processor, cause the performance of the apparatus.

According to a second aspect there is provided an apparatus comprising at least one processor; and at least one memory including computer program code; the at least one memory and the computer program code configured to, with the at least one processor, cause the apparatus at least to perform: when the apparatus is in an INACTIVE radio resource control state, transitioning from the INACTIVE radio resource control state to an IDLE radio resource control state, when it is determined by the apparatus that the apparatus has performed a radio access network notification area update a number of times that is equal to or greater than a configured number, N.

According to a third aspect there is provided an apparatus comprising: transitioning circuitry for, when the apparatus is in an INACTIVE radio resource control state, transitioning from the INACTIVE radio resource control state to an IDLE radio resource control state, when it is determined by the apparatus that the apparatus has performed a radio access network notification area update a number of times that is equal to or greater than a configured number, N.

According to a fourth aspect there is provided a method comprising: when an apparatus is in an INACTIVE radio resource control state, transitioning from the INACTIVE radio resource control state to an IDLE radio resource control state, when it is determined by the apparatus that the apparatus has performed a radio access network notification area update a number of times that is equal to or greater than a configured number, N.

According to some examples, the method comprises operating a timer to determine whether the apparatus has performed a radio access network notification area update a number of times that is equal to or greater than the configured number, N, within a time window.

According to some examples, each radio access network notification area update is due to one or more of: movement of the apparatus; environmental factors; cell movement.

According to some examples, the method comprises changing from the INACTIVE radio resource control state to the IDLE radio resource control state instead of initiating a radio access network notification area update procedure with a network.

According to some examples, the method comprises determining a number of traffic events, x, experienced by the apparatus over a time window, y.

According to some examples, the method comprises performing the transitioning from the INACTIVE radio resource control state to the IDLE radio resource control state, when it is determined by the apparatus that the apparatus has performed a radio access network notification area update a number of times that is equal to or greater than the configured number, N, and the number of traffic events is less than or equal to x.

According to some examples, the configured number, N, takes in to account information of one or more of: movement of the apparatus; downlink traffic of the apparatus; uplink traffic of the apparatus; a number of other apparatus in the INACTIVE state; cell movement.

According to some examples, N is configured by the apparatus.

According to some examples, N is network configured.

According to some examples, once in the IDLE state, the method comprises listening for network paging messages according to an IDLE configuration, unless the apparatus had an apparatus-specific paging configuration in the INACTIVE state, in which case the apparatus continues using the apparatus-specific paging configuration when in the IDLE state.

According to some examples, the method comprises simultaneously supporting INACTIVE and IDLE paging at the apparatus.

According to some examples, the method comprises supporting the INACTIVE and IDLE paging during a time period set by a timer, the time period based on radio access network notification area update periodicity and a last periodic radio access network notification area update that was made.

According to some examples, the apparatus comprises a user equipment.

According to a fifth aspect there is provided a computer program comprising instructions for causing an apparatus to perform at least the following: when the apparatus is in an INACTIVE radio resource control state, transitioning from the INACTIVE radio resource control state to an IDLE radio resource control state, when it is determined by the apparatus that the apparatus has performed a radio access network notification area update a number of times that is equal to or greater than a configured number, N.

According to a sixth aspect there is provided a computer program comprising instructions stored thereon for performing at least the following: when an apparatus is in an INACTIVE radio resource control state, transitioning from the INACTIVE radio resource control state to an IDLE radio resource control state, when it is determined by the apparatus that the apparatus has performed a radio access network notification area update a number of times that is equal to or greater than a configured number, N.

According to a seventh aspect there is provided a non-transitory computer readable medium comprising program instructions for causing an apparatus to perform at least the following: when the apparatus is in an INACTIVE radio resource control state, transitioning from the INACTIVE radio resource control state to an IDLE radio resource control state, when it is determined by the apparatus that the apparatus has performed a radio access network notification area update a number of times that is equal to or greater than a configured number, N.

According to an eighth aspect there is provided a non-transitory computer readable medium comprising program instructions stored thereon for performing at least the following: when an apparatus is in an INACTIVE radio resource control state, transitioning from the INACTIVE radio resource control state to an IDLE radio resource control state, when it is determined by the apparatus that the apparatus has performed a radio access network notification area update a number of times that is equal to or greater than a configured number, N.

According to a ninth aspect there is provided an apparatus comprising means for performing: sending a configuration to a user equipment, the configuration comprising a number, N, which specifies how many times the user equipment when in an INACTIVE radio resource control state may perform a radio access network notification area update before transitioning from the INACTIVE radio resource control state to an IDLE radio resource control state.

According to some examples, each radio access network notification area update is due to one or more of: movement of the user equipment; environmental factors; cell movement.

According to some examples, the means are further configured to perform specifying to the user equipment a number of traffic events, x, and a time window, y, such that the configuration sent to the user equipment specifies that the user equipment may transition from the INACTIVE radio resource control state to the IDLE radio resource control state when the user equipment has performed a radio access network notification area update a number of times that is equal to or greater than N and the number of traffic events is less than or equal to x.

According to some examples, the configured number, N, takes in to account information of one or more of: movement of the user equipment; downlink traffic of the user equipment; uplink traffic of the user equipment; a number of other user equipment in the INACTIVE state; cell movement.

According to some examples, the apparatus comprises a network apparatus.

According to some examples, the apparatus comprises a base station and the configuration is sent to the user equipment as part of radio resource control and/or system information block signalling.

According to a tenth aspect there is provided an apparatus comprising at least one processor; and at least one memory including computer program code; the at least one memory and the computer program code configured to, with the at least one processor, cause the apparatus at least to perform: sending a configuration to a user equipment, the configuration comprising a number, N, which specifies how many times the user equipment when in an INACTIVE radio resource control state may perform a radio access network notification area update before transitioning from the INACTIVE radio resource control state to an IDLE radio resource control state.

According to an eleventh aspect there is provided an apparatus comprising: sending circuitry for sending a configuration to a user equipment, the configuration comprising a number, N, which specifies how many times the user equipment when in an INACTIVE radio resource control state may perform a radio access network notification area update before transitioning from the INACTIVE radio resource control state to an IDLE radio resource control state.

According to a twelfth aspect there is provided a method comprising: when an apparatus is in an INACTIVE radio resource control state, transitioning from the INACTIVE radio resource control state to an IDLE radio resource control state, when it is determined by the apparatus that the apparatus has performed a radio access network notification area update a number of times that is equal to or greater than a configured number, N.

According to some examples, each radio access network notification area update is due to one or more of: movement of the user equipment; environmental factors; cell movement.

According to some examples the method comprises specifying to the user equipment a number of traffic events, x, and a time window, y, such that the configuration sent to the user equipment specifies that the user equipment may transition from the INACTIVE radio resource control state to the IDLE radio resource control state when the user equipment has performed a radio access network notification area update a number of times that is equal to or greater than N and the number of traffic events is less than or equal to x.

According to some examples the configured number, N, takes in to account information of one or more of: movement of the user equipment; downlink traffic of the user equipment; uplink traffic of the user equipment; a number of other user equipment in the INACTIVE state; cell movement.

According to some examples, the apparatus comprises a network apparatus.

According to some examples, the apparatus comprises a base station and the configuration is sent to the user equipment as part of radio resource control and/or system information block signalling.

According to a thirteenth aspect there is provided a computer program comprising instructions for causing an apparatus to perform at least the following: sending a configuration to a user equipment, the configuration comprising a number, N, which specifies how many times the user equipment when in an INACTIVE radio resource control state may perform a radio access network notification area update before transitioning from the INACTIVE radio resource control state to an IDLE radio resource control state.

According to a fourteenth aspect there is provided a computer program comprising instructions stored thereon for performing at least the following: sending a configuration to a user equipment, the configuration comprising a number, N, which specifies how many times the user equipment when in an INACTIVE radio resource control state may perform a radio access network notification area update before transitioning from the INACTIVE radio resource control state to an IDLE radio resource control state.

According to a fifteenth aspect there is provided a non-transitory computer readable medium comprising program instructions for causing an apparatus to perform at least the following: sending a configuration to a user equipment, the configuration comprising a number, N, which specifies how many times the user equipment when in an INACTIVE radio resource control state may perform a radio access network notification area update before transitioning from the INACTIVE radio resource control state to an IDLE radio resource control state.

According to an sixteenth aspect there is provided a non-transitory computer readable medium comprising program instructions stored thereon for performing at least the following: sending a configuration to a user equipment, the configuration comprising a number, N, which specifies how many times the user equipment when in an INACTIVE radio resource control state may perform a radio access network notification area update before transitioning from the INACTIVE radio resource control state to an IDLE radio resource control state.

### BRIEF DESCRIPTION OF FIGURES

The invention will now be described in further detail, by way of example only, with reference to the following examples and accompanying drawings, in which:

FIG. 1 schematically shows the 5G RRC states;

FIG. 2 schematically shows a RAN notification area by way of example;

FIG. 3 is a signalling diagram showing signalling between a user equipment and base stations;

FIG. 4 is a flow-chart of a method according to an example;

FIG. 5 is a flow-chart of a method according to an example;

FIG. 6 is a signalling diagram according to an example;

FIG. 7 schematically shows parts of a user equipment according to an example;

FIG. 8 schematically shows parts of a control apparatus according to an example;

FIG. 9 is a flow-chart of a method according to an example;

FIG. 10 is a flow-chart of a method according to an example.

### DETAILED DESCRIPTION

The present disclosure is in the context of the 5G communication systems and relates to mechanisms for implementing a more energy efficient user equipment (UE), and describes mechanisms for moving UE from the RRC_INACTIVE state to the RRC_IDLE state. More particularly, the present disclosure relates to the newly agreed Rel-16 study item RP-181463 “Study on UE Power Saving in NR”, June 2018 and corresponding TR 38.840.

A new independent RRC state, referred to as RRC_INACTIVE, was introduced in 3GPP NR Rel-15, complementing the existing states, RRC_CONNECTED and RRC_IDLE, with a goal of lean signalling and energy efficient support of NR services. Although the design was conceived particularly for massive machine type communications/massive internet of things (mMTC/MIoT) services, the RRC_INACTIVE state could be beneficial to efficiently deliver small/infrequent traffic of enhanced mobile broadband (eMBB) services as well.

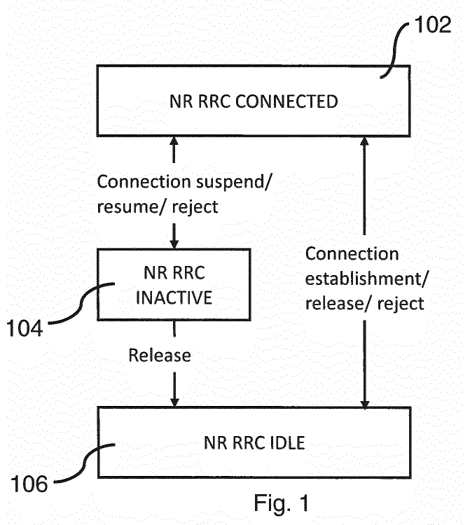

The NR RRC state machinery is illustrated in FIG. 1. The RRC_CONNECTED state is schematically shown at 102, the RRC_INACTIVE state is schematically shown at 104, and the RRC_IDLE state is schematically shown at 106. The RRC_INACTIVE state 104 enables a quicker start to the transmission of small or sporadic data with much lower delay compared to when the UE is in the RRC_IDLE state 106. Note that in order to transfer data the UE needs to be transitioned to the RRC_CONNECTED state 102. The lower delay, obtained with RRC_INACTIVE, is achieved mainly due to reduced control signalling required for requesting and obtaining the resumption of a suspended RRC connection. The RRC connection can only be suspended when the UE moves from RRC_CONNECTED to RRC_INACTIVE, while a move to RRC_IDLE would result in a RRC connection release. This results in UE power saving. The main gain mechanism is fewer messages transmitted over a shorter time duration to become active for data communication, when transitioning to RRC_CONNECTED from RRC_INACTIVE compared to from RRC_IDLE. At the same time, a UE in RRC_INACTIVE state 104 is able to achieve similar power savings as in RRC_IDLE state 106, benefiting from e.g. a much larger period of physical downlink control channel (PDCCH) monitoring (e.g. paging) and relaxed measurements compared to RRC_CONNECTED. Furthermore, compared to keeping the UE in RRC_CONNECTED state 102, the RRC_INACTIVE state 104 minimizes mobility signalling both to the radio access network (RAN) (e.g. RRC measurement reporting, handover (HO)/cell reselection messages) and to the core network (e.g. to/from the access and mobility management function (AMF)). When a UE is moved to RRC_INACTIVE, the UE access stratum context (referred to as UE Inactive AS Context), necessary for the quick resumption of the connection, is maintained both at the UE side and RAN side, and it is identified by the UE identifier, i.e. Inactive radio network temporary identifier (I-RNTI). There are three different I-RNTI profiles, each allocating 16-24 bits to define a UE specific reference and a gNB ID, in total 40 bits [TR 38.300].

It is noted that the transition RRC_INACTIVE to RRC_IDLE is network initiated. In typical scenarios, the UE has to move to RRC CONNECTED first (after sending a resume request), before its RRC connection can be released. In failure scenarios, when the UE context cannot be retrieved, the gNB can indicate an RRC release upon receiving the resume request.

While in RRC_INACTIVE state, the UE can move transparently to the RAN (i.e. without the RAN knowing) within a RAN Notification area (RNA), within which the UE can be paged from the RAN (using the I-RNTI) rather than from the core network [TR 38.300]. For example the RAN only knows the UE is in a specific RNA, which can consist of multiple cells. The RAN will then page the UE in all the cells that belong to the RNA, when the RAN needs to contact the UE.

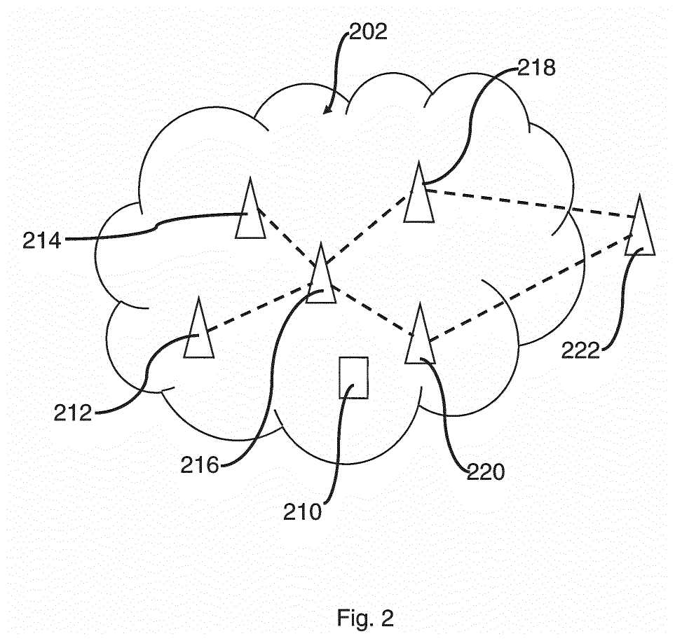

The RNA concept is schematically shown with respect to FIG. 2. FIG. 2 shows an RNA 202. An RNA can cover a single or multiple cells, and can be smaller than tracking area (TA). In the example of FIG. 2 the RNA 202 comprises five cells or base stations, namely base stations 212, 214, 216, 218 and 220. A UE is schematically shown at 210. As long as UE 210 stays within RNA 202, the UE 210 does not send any location updates (e.g. RNAU) to the network. If on the other hand the UE 210 moves to cell 222 (which is outside RNA 202), then a RNA update (i.e. location update notification) will be sent to the network.

Whenever the assigned RNA of a UE changes, an RNA Update procedure (RNAU) will be performed, by the UE, similarly to the tracking area update (TAU) procedure used for large scale mobility in RRC Idle mode. The RNAU could be due to movement of the UE (i.e. the UE crossing an RNA border), or due to a change in the location or area of an RNA. That is in some examples one or more RNAs may be modified such that a UE finds itself in a new or different RNA, whether or not the UE has moved. The core network (CN) is not aware of whether the UE state is RRC_Connected or RRC_Inactive. A UE in the RRC_INACTIVE state is required to initiate the RNA update (RNAU) procedure periodically, and when it moves out of the configured RNA. When receiving an RNA update request from the UE (i.e. resume request with “resumeCause” set to “ma-Update”), the receiving gNB triggers an XnAP Retrieve UE Context procedure to get the UE context from the last serving gNB (if able to resolve the gNB identity contained in the I-RNTI), and may decide to send the UE back to RRC_INACTIVE state, move the UE into RRC_CONNECTED state, or send the UE to RRC_IDLE. In case of periodic RNA update, if the last serving gNB decides not to relocate the UE context, the last serving gNB fails the Retrieve UE Context procedure and sends the UE back to RRC_INACTIVE, or to RRC_IDLE directly by an encapsulated RRCRelease message as shown in the signalling diagram of FIG. 2.

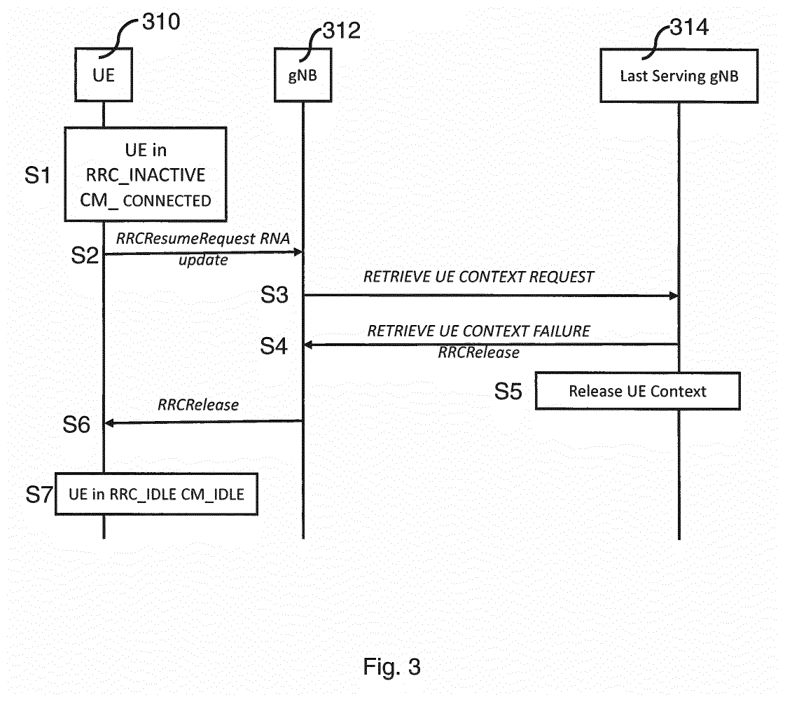

In FIG. 3, signalling is schematically shown between a UE 310, a base station (gNB) 312 (i.e. a new gNB that the UE 310 wants to connect to), and a last serving base station (e.g. gNB) 314 (i.e. a gNB the UE is being handed over or reselected from) The handover/reselection from gNB 314 to gNB 312 may be due to, for example, UE movement or that the environment has changed (for example a large truck causes the signal from gNB 314 to be blocked). It is to be noted that the example of FIG. 3 is an example where the UE context is not retrieved. In other examples UE context may be successfully retrieved.

As shown at S1, initially the UE 310 is in a RRC_INACTIVE and CM_CONNECTED state. CM refers to Connection Management (defined in TS 23.501), and defines the NAS (Non-access stratum) signalling between UE and the AMF (access and mobility management function). A CM_IDLE UE has no NAS signalling connection with the AMF, while the CM_CONNECTED UE has such a NAS signalling connection. The connection is established through the RRC Connection (i.e. through the RAN).

At S2, the UE 310 sends an RRC resume request RNA update to gNB 312.

In response, at S3 the gNB 312 sends a retrieve UE context request message to last serving gNB 314.

At S4, the last serving gNB 314 sends a retrieve UE context failure RRC release message to gNB 312.

At S5, the UE context is released at the last serving gNB 314.

At S6, the gNB 312 sends an RRC release message to the UE 310.

In response to receiving this message, at S7 the UE 310 is placed in RRC_IDLE and CM_IDLE mode.

Another scenario in which the UE in RRC_INACTIVE state may move to RRC_IDLE state, is when the UE fails to find a suitable cell and camps on the acceptable cell to obtain limited service as defined in TS 38.304. In such case, the UE performs the actions upon going to RRC_IDLE, comprising indicating the release of the RRC connection to upper layers.

There is a problem that an RRC_INACTIVE UE may be subjected to an RNAU. As explained above this could be due to movement of the UE, environmental factors, or cell movement. For example and with regard to cell movement, in non-terrestrial networks the gNBs (on board satellites) move and thus that may also trigger the RNAU. TR 38.821 discusses solutions for NR to support non-terrestrial networks. The number and/or frequency of RNAUs may depend on one or more of: RNA size; UE speed; UE trajectory. Thus in some examples there may be frequent RNAUs. This may trigger the RNAU procedure frequently and the associated signalling will result in increased UE power consumption, which is undesired. This poses challenges to the network. First, the network may not be aware of the UE mobility status. Second, the network may not want to construct large or larger RNA areas to limit the RNAU procedures triggered by mobile UEs, since that would result in burdensome RAN paging, because the paging of a UE would be sent in more cells.

One option would be for the network to define the RNA areas with an aim of keeping the RAN paging limited irrespective of the UE mobility. When the (high) UE mobility is revealed at the network by the reception of frequent RNAU signalling from the UE, the network could decide to move the UE to the RRC_IDLE state. However, that comes at the cost of signalling and UE power consumption.

As will be explained in more detail below, the present disclosure targets further power savings in RRC_INACTIVE related to the RNAU procedure for mobile UEs. Examples of the present disclosure also reduce network management complexity, by avoiding optimized planning of the RNA e.g. as a function of the UE mobility state.

According to some examples, a UE in RRC_INACTIVE state transitions (or moves or changes) autonomously to the RRC_IDLE state when there have been N or more RNAUs. N could be any positive integer. In some examples N=1. In some examples N is network configured. In some examples N is configured by the UE. Such RRC state transition is carried out, if allowed by the network, rather than initiating the RNA update procedure, therefore avoiding the associated signalling and power consumption. In some examples N is counted over a predetermined period of time. That is in some examples a UE in RRC_INACTIVE state transitions autonomously to the RRC_IDLE state when there have been N or more RNAUs over a given time period. The UE may have a timer for monitoring the time period. In some examples, by “autonomous” is meant that the UE can perform the transition itself without necessarily requiring a specific instruction to do so from the network at the time of transition.

In some examples, one or more conditions can be indicated by the network to trigger the autonomous transitioning to RRC_IDLE. One condition may be traffic statistics. The traffic can be UE originating or UE terminating, or indeed a combination of both. This may minimize the likelihood that a moving UE enters RRC_IDLE mode even though the UE performs frequent data transfers. A UE frequently transitioning or “ping-ponging” between RRC_IDLE and RRC_CONNECTED would incur a significant signalling overhead and high UE energy consumption.

According to some examples, after moving to the RRC_IDLE state, the UE stops sending the periodic RNA Update. The UE may instead perform less frequent tracking area (TA) updates, because the TA is usually larger than the RNA. At the network side, a timer may run so as to monitor frequency of RNA updates from the UE. When the timer expires without a notification from the UE, the gNB can remove the UE context and assume the UE is now in RRC_IDLE. Thus in some examples the gNB may comprise a timer.

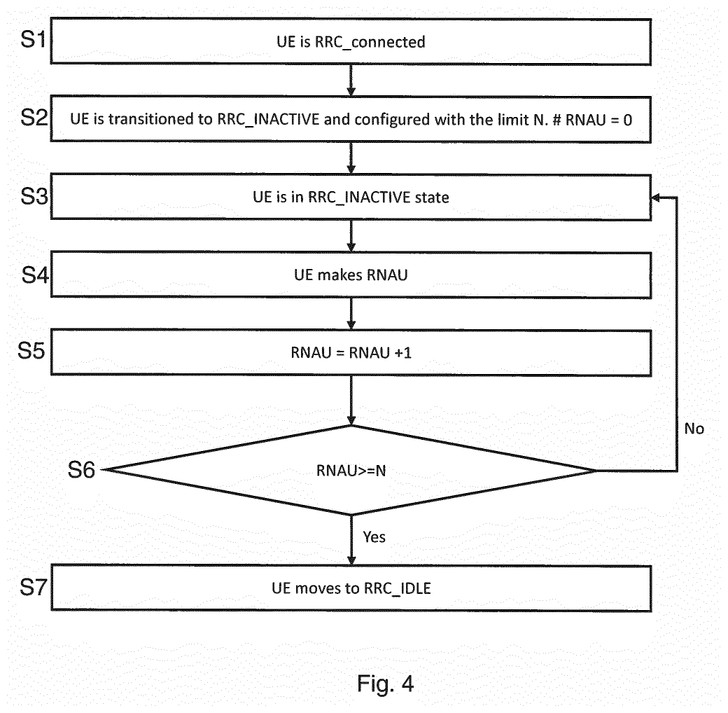

One example will now be described in further detail with reference to the flow chart of FIG. 4.

As shown at S1, the UE is initially in RRC_CONNECTED state.

The UE is then transitioned to the RRC_INACTIVE state, as shown at S2. In some examples the transition to the INACTIVE state occurs after a period of inactivity of the UE. Usually the network will apply a proprietary “RRC release timer”, which detects traffic activity. When no traffic has occurred within the timer, the UE is moved to either RRC Inactive or Idle.

Before or during the INACTIVE state, the UE receives network signalling from the network. The network signalling configures the number of RAN notification area updates (N) the UE can make before the UE may move autonomously to RRC_IDLE. According to some examples the network may define the value of N. In so doing the network may take one or more of the following factors in to account: prior knowledge of UE movement; downlink traffic; uplink traffic; total number of RRC_INACTIVE UEs. Thus as shown at S2 the UE is configured with the limit N. At this point the number of RNAUs=0.

Therefore at S3, the UE is in the RRC_INACTIVE state. At each RAN notification area update the UE checks whether the sum of updates equals N or is greater than N.

In this example, at S4 the UE undertakes a RNAU.

Accordingly the count of RNAUs is increased by 1. This is schematically shown at S5 where the (new) RNAU count=(previous) RNAU count+1.

At S6, the UE makes the determination of whether the RNAU count is equal to or greater than the configured value N.

If it is determined at S6 that the RNAU count is not equal to or greater than N i.e. determination=“No”), then the method loops back to S3.

If on the other hand it is determined at S6 that the RNAU count is equal to or greater than N (i.e. determination=“Yes”), then the method proceeds to S7, where the UE moves to the RRC_IDLE state. According to some examples the UE transitions between RRC states autonomously. According to some examples the UE moves autonomously to RRC_IDLE without performing any resumption of RNAU procedure.

Therefore as shown at S7 the UE is in RRC_IDLE state. According to some examples the RRC_IDLE configuration of the UE is broadcast by the network. In some examples the broadcast includes the paging periodicity of the UE. Thus the UE follows those definitions (e.g. paging periodicity). In some examples, if the UE was using a user-specific paging periodicity in RRC_INACTIVE state, the UE may continue using the user-specific paging periodicity after moving to RRC_IDLE, according to its validity.

According to some examples, when the UE decides to move from RRC_INACTIVE to RRC_IDLE, the UE listens for paging messages from the network using the RRC_IDLE configuration. The RRC_IDLE configuration is broadcast by the network (or user-specific configuration is used by the UE, if a user-specific configuration is available and valid). However, the network is not aware of the changed RRC state of the UE. Thus the network may attempt to page the UE using the RRC_INACTIVE configuration. The UE will not respond to such paging, since the UE is listening according to the RRC_IDLE paging configuration (if the configuration used in Idle mode differs from what is expected by the network). Thus the network will then need to attempt paging using the RRC_IDLE configuration. In some examples when the UE does not react to the RRC Inactive paging the network realizes the UE has transitioned to Idle. In other examples the NW may also use the knowledge that since UE was configured with maximum N RNAUs and had already sent N−1 RNAUs the UE is probably in RRC Idle. This delay in paging (and wasted RRC Inactive paging resource) may be considered a worthwhile trade-off for the improved UE battery life.

In some examples the UE covers both paging according to Inactive and Idle for a period. The period may be monitored by a timer. In some examples the timer period is based on RNAU periodicity and last periodic RNA update which was made. This is to make sure that during the transition in which the network has not yet discovered that the UE has moved to Idle, no additional paging latency is caused. Therefore it may be considered in some examples that the UE can simultaneously support INACTIVE and IDLE paging.

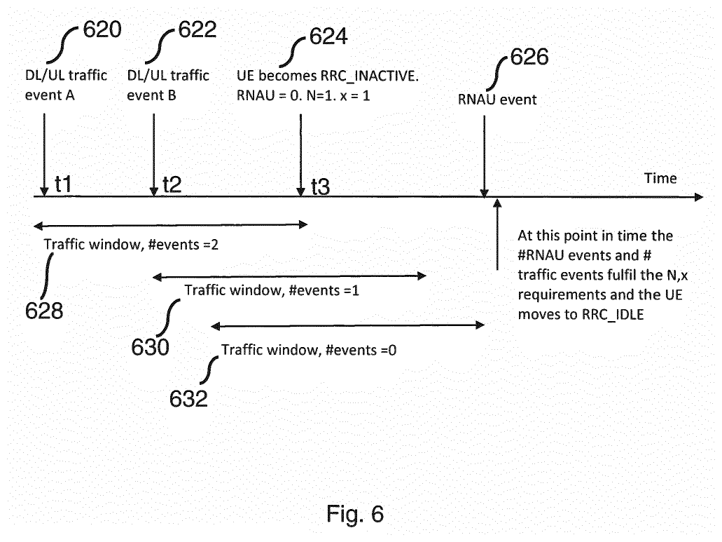

In some examples the UE may complement the RRC state change decision based on N RNA changes with knowledge about past data traffic of the UE. For example if the UE frequently transmits uplink data/receives downlink data, it may be more energy efficient for the UE to remain in RRC_INACTIVE state, since the state change to RRC_CONNECTED is faster from RRC_INACTIVE as compared to changing from RRC_IDLE. However, if the UE has observed an allowed maximum x individual data transmissions within a moving time window of y seconds, the UE may choose to move to RRC_IDLE, when N RNA changes are observed. The x and y values are configured by the network. The concept of a moving time window is further explained with respect to FIG. 6.

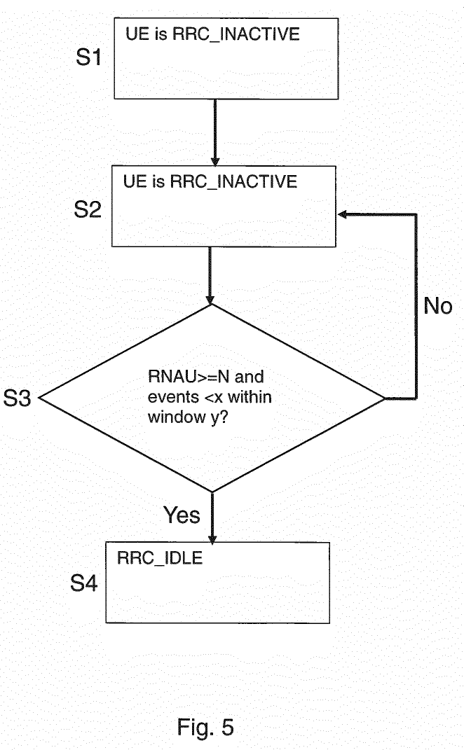

An example is now described in more detail with respect to FIG. 5.

At S1, the UE is in RRC_INACTIVE state. In this example the network has configured that the UE may move to RRC_IDLE after N RAN notification area updates (N). Also, in this example the network has configured the UE with a traffic time window of y seconds and maximum number of traffic events per window of x.

Therefore as shown at S2 the UE is in state RRC_INACTIVE.

As shown at S3, at each RAN notification area update the UE determines whether the sum of changes is equal to or greater than N. At each RAN notification area update the UE also updates the running window y to determine the number of traffic events that have occurred in the window y.

When the sum of RNA changes is equal to or greater than N, and the number of observed traffic events within the window y does not exceed x, the UE moves autonomously to RRC_IDLE, as shown at S4. The RRC_IDLE configuration including paging periodicity is broadcast by the network, and the UE follows the definitions provided in the broadcast (e.g. the paging periodicity).

When, on the other hand, the sum of changes is less than N, and/or the number of observed traffic events within the window y does exceed x, the method loops back to S2.

This concept is further illustrated in the schematic timeline of FIG. 6, which is a timeline of events at a UE.

A first DL/UL traffic event (“event A”) is schematically shown at 620, which occurs at time t1.

A second DL/UL traffic event (“event B”) is schematically shown at 622, which occurs at time t2.

The UE becomes RRC_INACTIVE as shown at 624, at time t3. RNAU=0, N=1, and x=1.

An RNAU event occurs as shown at 626.

A first time window is shown at 628. During the first time window there are two DL/UL events (i.e. event A and event B).

A second time window is shown at 630. During the second time window there is one DL/UL event (i.e. event B).

A third time window is shown at 632. There are no DL/UL events during the third time window.

In the example of FIG. 6, at RNAU event 626 the number of RNAU events and traffic events fulfil the N and x requirements and the UE moves to RRC_IDLE.

From FIG. 6 the concept of a moving time window can be appreciated. At time t3 the window covers the past time from t1 to t3. A bit after time t3 (i.e. “t3+some time”) the window has updated and now covers t2 to “t3+some time”. Thus the window is moving in time, and the data event that occurred at t1 is no longer part of the new window.

It will be appreciated that examples allow power savings in RRC_INACTIVE by avoiding the RNAU procedure for mobile UEs. At the same time, examples may reduce the network management complexity, by avoiding optimized planning of the RNA, e.g. as function of the UE mobility state. In examples, the network can define the RNA's size according to RAN paging targets (e.g. avoiding paging from a too large number of cells), without incurring an increased power consumption for mobile UEs.

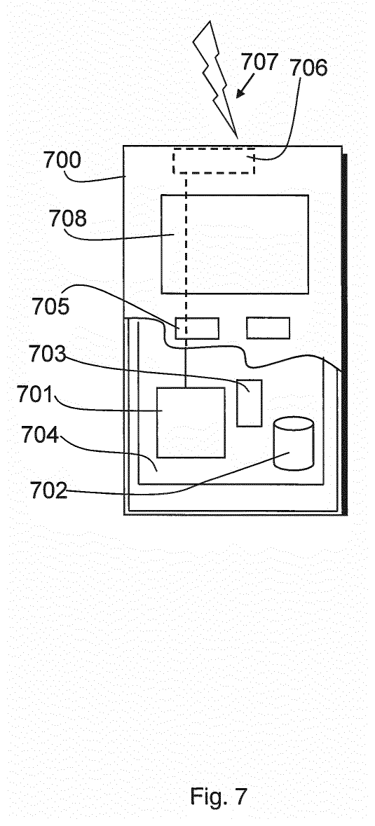

A possible wireless communication device which may operate in accordance with this disclosure will now be described in more detail with reference to FIG. 7 showing a schematic, partially sectioned view of a communication device 700. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a “smart phone”, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may be for example a mobile device, that is, a device not fixed to a particular location, or it may be a stationary device. The wireless device may need human interaction for communication, or may not need human interaction for communication. In the present teachings the terms UE or “user” are used to refer to any type of wireless communication device.

The wireless device 700 may receive signals over an air or radio interface 707 via appropriate apparatus for receiving and may transmit signals via appropriate apparatus for transmitting radio signals. In FIG. 7 transceiver apparatus is designated schematically by block 706. The transceiver apparatus 706 may be provided for example by means of a radio part and associated antenna arrangement. The antenna arrangement may be arranged internally or externally to the wireless device.

A wireless device is typically provided with at least one data processing entity 701, at least one memory 702 and other possible components 703 for use in software and hardware aided execution of tasks it is designed to perform, including control of access to and communications with access systems and other communication devices. The processor 701 (and in some examples the memory 702 and the components 703) may generally be considered means configured to perform one or more actions. The data processing, storage and other relevant control apparatus can be provided on an appropriate circuit board and/or in chipsets. This feature is denoted by reference 704. The user may control the operation of the wireless device by means of a suitable user interface such as key pad 705, voice commands, touch sensitive screen or pad, combinations thereof or the like. A display 708, a speaker and a microphone can be also provided. Furthermore, a wireless communication device may comprise appropriate connectors (either wired or wireless) to other devices and/or for connecting external accessories, for example hands-free equipment, thereto.

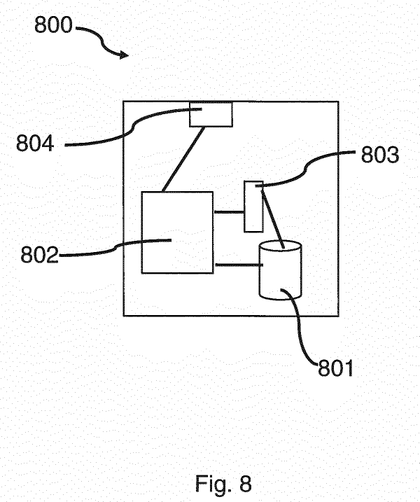

FIG. 8 shows an example of a control apparatus for a communication system which may operate in accordance with examples of the present disclosure, for example to be coupled to and/or for controlling a station of an access system, such as a RAN node, e.g. a base station, gNB, a central unit of a cloud architecture or a node of a core network such as an MME or S-GW, a scheduling entity such as a spectrum management entity, or a server or host. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 800 can be arranged to provide control on communications in the service area of the system. The control apparatus 800 comprises at least one memory 801, at least one data processing unit 802, 803 and an input/output interface 804. The data processing unit 802, 803 (and in some examples the memory 801) may generally be considered to comprise means configured to perform one or more actions. Via the interface 804 the control apparatus can be coupled to a receiver and a transmitter of the base station. The receiver and/or the transmitter may be implemented as a radio front end or a remote radio head. For example the control apparatus 800 or processor 801 can be configured to execute an appropriate software code to provide the control functions.

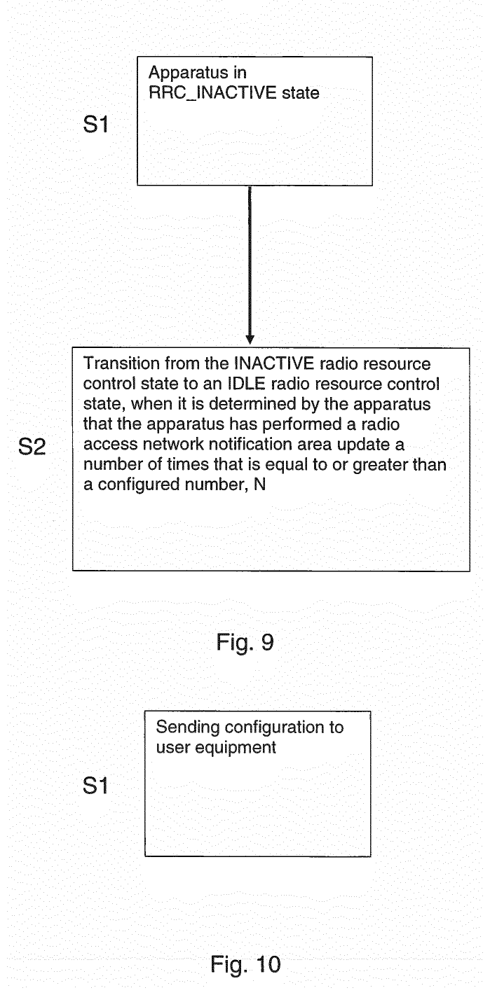

FIG. 9 is a flow-chart of a method according to an example. The flow chart of FIG. 9 is viewed from the perspective of an apparatus. The apparatus may for example comprise a user equipment.

As shown at S1, the apparatus is in an RRC_INACTIVE state.

As shown at S2, the method comprises the apparatus transitioning from the INACTIVE radio resource control state to an IDLE radio resource control state, when it is determined by the apparatus that the apparatus has performed a radio access network notification area update a number of times that is equal to or greater than a configured number, N.

Although not shown in FIG. 9, the method may also comprise a step of receiving the configuration from the network (e.g. from a gNB). To this end the apparatus may comprise a means for receiving, such as a receiver or transceiver.

FIG. 10 is a flow-chart of a method according to an example. The flow chart of FIG. 10 is viewed from the perspective of an apparatus. The apparatus may for example comprise a network apparatus. The network apparatus may for example comprise a base station, such as a gNB.

As shown at S1, the method comprises sending a configuration to a user equipment.

The configuration comprises a number, N, which specifies how many times the user equipment when in an INACTIVE radio resource control state may perform a radio access network notification area update before transitioning from the INACTIVE radio resource control state to an IDLE radio resource control state.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1. An apparatus comprising:
at least one processor; and
at least one memory including computer program code;
the at least one memory and the computer program code configured to, with the at least one processor, cause the apparatus at least to:
when the apparatus is in an INACTIVE radio resource control state, transition from the INACTIVE radio resource control state to an IDLE radio resource control state, when it is determined by the apparatus that the apparatus has performed a radio access network notification area update a number of times that is equal to or greater than a configured number, N.

2. The apparatus of claim 1, wherein the computer program code and the at least one processor are configured to cause the apparatus to operate a timer to determine whether the apparatus has performed a radio access network notification area update a number of times that is equal to or greater than the configured number, N, within a time window.

3. The apparatus of claim 1, wherein each radio access network notification area update is due to one or more of: movement of the apparatus; environmental factors; cell movement.

4. The apparatus of claim 1, wherein the computer program code and the at least one processor are further configured to cause the apparatus to change from the INACTIVE radio resource control state to the IDLE radio resource control state instead of initiating a radio access network notification area update procedure with a network.

5. The apparatus of claim 1, wherein the computer program code and the at least one processor are further configured to cause the apparatus to determine a number of traffic events, x, experienced by the apparatus over a time window, y.

6. The apparatus of claim 5, wherein the computer program code and the at least one processor are further configured to cause the apparatus to transition from the INACTIVE radio resource control state to the IDLE radio resource control state, when it is determined by the apparatus that the apparatus has performed a radio access network notification area update a number of times that is equal to or greater than the configured number, N, and the number of traffic events is less than or equal to x.

7. The apparatus of claim 1, wherein the configured number, N, takes in to account information of one or more of: movement of the apparatus; downlink traffic of the apparatus; uplink traffic of the apparatus; a number of other apparatus in the INACTIVE state; cell movement.

8. The apparatus according to claim 1, wherein N is configured by the apparatus.

9. The apparatus according to claim 1, wherein N is network configured.

10. The apparatus of claim 1, wherein the computer program code and the at least one processor are further configured to cause the apparatus to, once in the IDLE state, listen for or detect network paging messages according to an IDLE configuration, unless the apparatus had an apparatus-specific paging configuration in the INACTIVE state, in which case the apparatus is configured to continue using the apparatus-specific paging configuration when in the IDLE state.

11. The apparatus of claim 1, wherein the computer program code and the at least one processor are further configured to cause the apparatus to simultaneously support INACTIVE and IDLE paging.

12. The apparatus of claim 11, wherein the computer program code and the at least one processor are further configured to cause the apparatus to support the INACTIVE and IDLE paging during a time period set by a timer, the time period based on radio access network notification area update periodicity and a last periodic radio access network notification area update that was made.

13-14. (canceled)

15. An apparatus comprising:
at least one processor; and
at least one memory including computer program code;
the at least one memory and the computer program code configured to, with the at least one processor, cause the apparatus at least to:
send a configuration to a user equipment, the configuration comprising a number, N, which specifies how many times the user equipment when in an INACTIVE radio resource control state may perform a radio access network notification area update before transitioning from the INACTIVE radio resource control state to an IDLE radio resource control state.

16. The apparatus according to claim 15, wherein each radio access network notification area update is due to one or more of: movement of the user equipment; environmental factors; cell movement.

17. The apparatus of claim 15, wherein the computer program code and the at least one processor are further configured to cause the apparatus to specify to the user equipment a number of traffic events, x, and a time window, y, such that the configuration sent to the user equipment specifies that the user equipment may transition from the INACTIVE radio resource control state to the IDLE radio resource control state when the user equipment has performed a radio access network notification area update a number of times that is equal to or greater than N and the number of traffic events is less than or equal to x.

18. The apparatus of claim 15, wherein the configured number, N, takes in to account information of one or more of: movement of the user equipment; downlink traffic of the user equipment; uplink traffic of the user equipment; a number of other user equipment in the INACTIVE state; cell movement.

19. The apparatus of claim 15, wherein the apparatus comprises a network apparatus.

20. The apparatus of claim 15, wherein the apparatus comprises a base station and the configuration is sent to the user equipment as part of radio resource control and/or system information block signalling.

21-25. (canceled)
